(19) United States
(12) Patent Application Publication
(10) Pub. No.: US 2008/0060553 A1
(43) Pub. Date: Mar. 13, 2008

(54) Chromophore Coating Systems, Especiallly Paints And Lacquers

(75) Inventors: Hans-Joachim Guttler, Duren (DE); Hans-Achim Brand, Duren (DE)

Correspondence Address: BACHMAN & LAPOINTE, P.C., 900 CHAPEL STREET, SUITE 1201, NEW HAVEN, CT, 06510, US

(73) Assignee: Ewald Dorken AG, Herdecke (DE)

(21) Appl. No.: 11/816,010

(22) PCT Filed: Feb. 13, 2006
(86) PCT No.: PCT/EP06/01300

§ 371 Date: Oct. 22, 2007

(30) Foreign Application Priority Data
Feb. 11, 2005 (DE) 10 2005 006 591.0
Jun. 1, 2005 (DE) 20 2005 008 677.0

(51) Int. Cl. C09D 5/00

(52) U.S. Cl. 106/400

(57) ABSTRACT

A coating system for the chromophoric coating of surfaces includes a liquid basic mass as a first component, and a second component having at least one pigment preparation in solid form, wherein the pigment preparation is soluble in the basic mass, and the pigment preparation is portioned, whereby the portion of the pigment preparation is always adjusted in proportion to a predetermined amount of liquid basic mass.

The present invention relates to chromophoric coating systems, in particular paints and lacquers.

Coatings for surfaces which are to be given a colored appearance are usually individually colored for the surface to be painted. While coatings precolored in the factory are available, they meet the requirements with respect to color selection only in a very limited way, because they are restricted to very few color hues. Chromophoric coating systems, referred to as paints or lacquers in short for clarity, are usually provided first in the factory as a white or colorless basic mass. Colored pigment preparations, usually pastes or so called tinting paints, having a lower pigment content than pastes, are mixed with the basic mass in order to produce each desired individual color hue by mixing. Preparation by mixing is done both manually using tinting paints and automatically in so called automatic tinting machines using pigment pastes. Mixing is usually carried out by the processing agent, i.e. the craftsperson, or his or her supplier, in the DIY shop or by the DIY craftsperson.

The direct use of chromophoric pigments is not suitable for manual mixing or for the use in automatic mixing machines. As a raw material, pigments are present in the form of agglomerates as solids, which cannot be directly mixed with paints or lacquers. For the manufacture of pigmented paints and lacquers, these agglomerates must first be reduced to primary particles using high shearing forces and using wetting and dispersing agents, to ensure that the pigments in paints or lacquers set free sufficient coloring effect in the first place. These primary particles will not remain stable in layers, which is why they are immediately further processed to pastes or tinting paints in the factory.

Document CH 630401 discloses the processing of pigments to tablets. Herein pigments, such as azo-pigments are pressed to a tablet together with sodium, potassium or ammonia salt of a polyacrylic acid. For dispersion, the tablet is dissolved in the binding paint.

As initially mentioned, pigments principally have a tendency, however, to form agglomerates, so that a satisfying color distribution cannot be achieved in the binding paint using the measures described in CH 630401. The use of pressed pigments is therefore not practicable.

This is why the problem of mixing individual color hues “on site” for smaller amounts of paint has not been solved. Smaller amounts of paint are needed however, to give color to smaller surfaces. Coloring smaller surfaces is a common application for paints and lacquers.

It is therefore an object of the present invention to provide a chromophoric coating system allowing the mixing of individual color hues in any desired amount, in particular in small amounts, to be carried out simply, cleanly and easily.

This object is solved by means of a coating system for the chromophoric coating of surfaces, comprising a liquid basic mass as a first component and a second component, comprising at least one pigment preparation in solid form, characterized in that the pigment preparation is portioned, wherein each portion of the pigment preparation is adjusted to the predetermined amount of the liquid basic mass and dissolvable in the basic mass.

Surprisingly it has been found that by dissolving the portioned dissolvable pigment preparation in the basic mass, without using pigments contained in a paste or a tinting paint as before, a much more accurate and reproducible tinting of the basic mass is achieved. The addition of predetermined portioned amounts of dissolvable pigment preparation in solid form allows for reproducible results even in small manually mixed amounts. The dissolvable pigment preparation is measured as a solid, whereby the amount of pigment preparation is adjusted in such a way that a predetermined amount of liquid basic mass results in a predetermined color hue after mixing in the portioned pigment preparation.

In the context of the present description, the term “dissolvable” shall also refer to any form of mixtures, solutions, dispersions etc, which occur in the context of the introduction of pigments in a basic mass.

The dissolving or introduction can be carried out manually or by means of an automatic mixing machine. However, it is assumed that often mixing will be manual, so that the coating system according to the present invention is configured for good manual mixability. Manual mixing of the pigment preparation in solid form requires intensive mixing of the basic mass, which can be carried out with simple means, however. A blunger which can be chucked in an electric hand drill is often used, which easily allows the standard amounts of binding paint (5 l, 10 l or 20 l) to be homogeneously tinted. Craftpersons or their suppliers often also use shakers to mix the paint or lacquer with pigment paste. These shakers may also easily be used to carry out the inventive tinting of basic mass using pigment preparations in solid form.

The term “dissolvable in the basic mass” in the context of the present invention means a pigment preparation which does not lead to the formation of agglomerates when stirred into a fluid basic mass, such as a binding paint or water. The pigments become easily dissolvable or dispersible if they are chemically treated in suitable pigment preparations or provided with a coating, which ensures that the finely ground pigments do not agglomerate when they are mixed into the liquid basic mass. Typical examples of such pigment preparations are mentioned in WO 2004/000903 or WO 03/066743, the subject matter of which is explicitly incorporated in the present patent application by reference. The idea of portioning used to have the drawback, that pigments in their original form as agglomerates are not mixable and that agglomerated pigments do not have a constant coloring effect according to present findings.

The pigments are usually flowable pigment preparations which are easily dispersible as a solid in the liquid basic mass and can therefore be homogeneously mixed into the basic mass. Such solid pigment preparations are usually already predispersed in a liquid and subsequently redried, e.g. spray dried. Such pigment preparations are dissolvable without great mechanic effort and are usually also referred to as “stir-in pigments”.

Suitable pigment preparations are sold, for example, by BASF under the trademark “X-Fast®”, by Lanxess Deutschland GmbH under the trademark “LEVANYL® Gran” and “LEVANOX® Gran”, by Clariant under the trademark “Colanyl® 400 Reihe” and by Rockwood Pigments (Brockhues) under the trademark “Granufin®”.

These pigment preparations are offered to the manufacturers of lacquers and paints in granulated form to be mixed in pigmented paints or lacquers in the factory. These pigmented paints or lacquers may now be manufactured in the factory with little effort in processing the pigments, both in view of the required apparatus and in view of the energy expenditure.

Pigment preparations in solid form according to the present invention are advantageous compared to tinting paints and pigment pastes in their practical application. On the one hand, the reproducibility of the mixing result is much greater when using pigment preparations in solid form than when using, for example, tinting paints. This is important, in particular, when small amounts of tinted paints or lacquers are needed or when additional amounts of an identical tinted paint or lacquer is needed. Renewed mixing of tinted paints or lacquers is often required in the DIY sector. The lack of precision in the tinting with tinting paint or pigment paste is due to the fact, among others, that the dosage of pigments in liquid or paste-like form is much more imprecise than the addition of portioned pigment preparations in solid form.

Further, the use of pigment preparations in solid form provides the possibility, hitherto not given, of producing mixed colors, in particular also with manual mixing, for example, in the DIY sector. Mixing of various tinting paints or pigment pastes in the basic mass does not lead to satisfactory results when mixed colors are made. The mixed color hues are not reproducible in a reliable manner. Herein, deviations are much greater than with “simple” tinting. Also, tinting paints are not available in a sufficiently wide range of color hues.

The introduction of mixtures of different pigment preparations into the basic mass has turned out to be particularly advantageous, however. In this case, mixtures of pigment preparations refer to both those mixtures already available as a portion of pigment preparations in a mixture, and mixing pigment portions of different color hues which, contrary to previous experience, also leads to reproducible mixing results when tinting a basic mass. A wide variety of colors and color hues can be provided in a simple manner. It is favorable to compile color charts which are based on mixing a plurality of portions of the same pigment preparation or a plurality of portions of different pigment preparations into the liquid basic mass. Since the added amount of pigment preparations is very small compared to the basic mass to be colored, a wide range of color hues can be provided in a simple and practicable manner by using the portioned pigment preparations. Also, very special color hues for particular applications, such as “spring colors”, can be achieved by mixing different pigment preparations in one pigment portion.

As an additional benefit, pigment preparations in solid form are advantageous both economically and ecologically; tinting paints and pigment pastes are marketed in standardized amounts from which only partial amounts are ever used for tinting. The leftovers dry up and must be disposed of. Since pigments are expensive as compared to the basic mass, only a comparatively small portion of the pigments is actually used for its intended purpose, a large portion must be disposed of at great cost. Even in the case where the entire contents of a bottle of tinting paint is used up by the consumer, dirty packaging must be disposed of, since the contents of the bottle can never be fully and cleanly poured out.

According to the present invention, the portioned pigment preparations to be mixed with the liquid basic mass are pressed according to a preferred embodiment in solid form (as powders or as granules) into portions, usually pellets or tablets. The manufacture of pellets or tablets of pigment preparations surprisingly does not adversely affect their mixability or dispersibility. The manufacture of pellets or tablets of the portioned pigment preparations is advantageous in that no dirty packaging is left over and in that each portion of the pigment preparation can be reliably handled and used.

According to a further developed embodiment, the pellets or tablets may be provided with auxiliary agents, which aid in the disintegration of the pellets or tablets within the basic mass or in a liquid. Substances releasing carbon dioxide when coming together with water are particularly suitable. Mechanically active disintegrating agents can also be added, such as suitable cellulose types, in particular CMC (carboximethylcellulose). Further examples of suitable disintegrating agents are disclosed in the documents EP 1 491 621 and EP 1 004 656, which are explicitly incorporated into the present patent application by reference.

Another preferred embodiment of the portioned pigment preparations is such that the pigment portion is surrounded by a water-soluble envelope. When the pigment portion is dosed to the liquid basic mass, the water-soluble envelope dissolves and the pigments color the liquid basic mass. To achieve this, it is possible, for example, to provide the portioned pigment preparation with a matrix envelope of CMC.

A considerable advantage of this embodiment is that accurate portioning is possible. In particular, processing or using a pigment portion is particularly clean, complete and residue free. The pigment portions provided with a liquid-, in particular water-soluble, envelope are suitable both for manually mixing pigment preparations in a liquid basic mass and for their automatic machine processing.

According to a particularly preferred embodiment, the pigment portions are marketed in at least two different portion amounts. A larger pigment portion can be used for adjusting a more intensive base color, which can then be nuancedly tinted by adding one or more smaller pigment portions having the same or different colors. This is how a substantially larger variety of color hues can be provided which can be mixed in an exactly reproducible manner, in particular for manual mixing.

In order to further increase the variability of the coating system according to the present invention, according to an advantageous embodiment, the pigment portions, in particular in the form of pellets or tablets, are provided with dividing markings, so that for example half or a quarter of a pigment portion can be selectively divided and dissolved in the base coat. This is how differentiations between different portion sizes can be achieved within one pellet or one tablet.

The pigment portions may be used for tinting a basic mass in a particularly effective manner, if pigment preparations are used which have been predispersed in liquid, in particular in water. Dissolving the pigment portions in small amounts of liquid, in proportion to the basic mass to be colored, and subsequent mixing of the dissolved pigments in the basic mass, substantially accelerates the mixing process. Homogeneous coloring of the basic mass is achieved already after short mixing. Dissolving the pigment, for example, in an amount of about 2% water with respect to the amount of basic mass to be colored, also makes it possible to check whether the pigments present in solid form are uniformly dispersed before the pigments are mixed in. This uniform dispersion is an essential precondition for rapid and uniform coloring of the basic mass. The reduction in mechanic mixing effort is considered particularly advantageous in the case of manual mixing.

The amount of pigment preparation necessary for tinting commercial amounts of binding paint or lacquer is very small. Tablets or pellets may therefore be very small. To improve the handling of the pigment preparations in solid form, it may be suitable to add fillers, which would give the tablets or pellets a practicable size, without the fillers having a negative affect on the mixing process. Common fillers can be inorganic or organic substances, such as chalk, barium sulfate, silicon dioxide, talcum, kaolin or the like. Preferably, they are substances which are compatible with the basic mass to be colored, in particular, also present in the basic mass, for example as an aggregate. To achieve particularly good solubility, the pigment proportion of the second component should preferably be less than 70% and particularly preferably less than 50%. The pigment proportion should always be selected depending on the color intensity of each pigment. For example, a high pigment proportion should be chosen with a yellow hue, whereas with violet, due to its high color intensity, a lower pigment proportion may already be sufficient. As a rule, however, the proportion should not be less than 20%.

To ensure uniform coloring of the basic mass, care has always been taken that the tinting paint and the basic mass have the same consistency, or that the pigment paste has a higher solids concentration than the basic mass to be colored. Persons skilled in the art have always assumed that thinning the basic mass by introducing pigments in liquid form changes the processing properties of the basic mass. Also, it is often not possible to store pigments for longer periods of time as a stable dispersion, for example, in water. Particularly for these reasons, it is advantageous to use pigment preparations in solid form.

In the context of the present invention, it has also been found surprisingly that the precision and repeatability of coloring the basic mass can be further optimized if a pigment preparation in solid form, for example, as a tablet, is predispersed in a small amount of liquid, in particular water, and then introduced into the basic mass. This is particularly advantageous with highly viscous basic mass. The amount of liquid to be added according to this process, of less than 5%, preferably of less than 2%, particularly preferably of less than 1% is so little, that it does not affect the usual processing properties of the basic mass. As a rule, it is not more than the amount of liquid which is necessary to make the basic mass processable. Since the pigments are not to be stored for a longer period of time in an aqueous solution according to the present method, the stability of the dispersion is quite immaterial.

Essential details of the invention will be more closely explained with reference to the following examples:

### EXAMPLE 1

8 g of pigment preparation of the color “green”, here an X-fast®-pigment of BASF, is pressed with 8 g CMC and 4 g talcum in a common tabletting plant and provided with two weakened lines to facilitate quartering of the tablet. Two of the above mentioned tablets are dispersed in 150 ml of water. The pigment dispersed in water is stirred in 5 l of a commercially available, clear aqueous acrylic lacquer. Stirring (duration: 1-2 minutes) is by hand and with a suitable stirring tool.

### EXAMPLE 2

2 tablets, as described in example 1, but with the pigment “red”, four tablets with the pigment “yellow” and half a tablet with the pigment “black” are added to 10 l of a commercially available interior decorating paint (white binding paint) and then stirred. Stirring is by means of a blunger, which is electrically operated, for the duration of 1 minute. Again, X-fast®-pigments of BASF are used for the colors red and yellow, and Granufin® Samt N 64 pigment of Rockwood Pigments (Brockhues) are used for the color black.

### EXAMPLE 3

1 tablet, as described in example 1, but with the pigment “orange” and 3 tablets with the pigment “ocher” are added to 15 l of house paint on a dispersion basis and manually stirred in using a suitable stirring tool (duration: 1-2 minutes). Pigments of Lanxess Deutschland GmbH are used: LEVANYL® Gran for the color orange and LEXANOX® Gran for the color ocher.

1. A coating system for the chromophoric coating of surfaces, comprising
a liquid basic mass as a first component, and
a second component comprising at least one pigment preparation in solid form,
characterized in that
the pigment preparation is soluble in the basic mass, and
the pigment preparation is portioned, whereby the portion of the pigment preparation is always adjusted in proportion to a predetermined amount of liquid basic mass.

2. The coating system according to claim 1, characterized in that the pigment preparation is a stir-in pigment.

3. The coating system according to claim 1, characterized in that mixtures of pigment preparations are used as the second component.

4. The coating system according to claim 1, characterized in that the pigment preparation is soluble in liquid.

5. The coating system according to claim 1, characterized in that the pigment preparation is formed in pellets or tablets.

6. The coating system according to claim 1, characterized in that the pigment preparation is surrounded by a liquid-soluble.

7. The coating system according to claim 1, characterized in that the portions of the pigment preparation are provided with dividing markings.

8. The coating system according to claim 1, characterized in that at least two different portion sizes of the pigment preparation are provided for the coating system.

9. The coating system according to claim 1, characterized in that pigment preparations provided with dispersing agents and/or aggregates are used.

10. The coating system according to claim 1, characterized in that the proportion of the pigment in the second component is smaller than 70%.

11. A method for coloring a basic mass, comprising the steps of:
dissolving a predetermined amount, in relation to a basic mass to be colored, of a pigment preparation in solid form in a liquid,
mixing the liquid with the dissolved pigment preparation with the basic mass to be colored.

12. The method according to claim 11, characterized in that the amount of liquid in which the pigment preparation is dissolved, is less than 5% of the amount of the basic mass to be colored.

13. The method according to claim 11, characterized in that it is carried out manually.

14. A chromophoric pigment portion, comprising a tablet or a pellet, provided for coloring a predetermined amount of basic mass.

15. A chromophoric pigment portion, comprising a tablet or a pellet, for use with a coating system according to claim 1.

16. The coating system according to claim 1, characterized in that the pigment preparation is soluble in water.

17. The coating system according to claim 1, characterized in that the pigment preparation is surrounded by a water-soluble envelope.

18. The coating system according to claim 1, characterized in that the proportion of the pigment in the second component is smaller than 50%.

19. The method according to claim 11, characterized in that the amount of liquid in which the pigment preparation is dissolved, is less than 2% of the amount of the basic mass to be colored.

20. The method according to claim 11, characterized in that the amount of liquid in which the pigment preparation is dissolved, is less than 1% of the amount of the basic mass to be colored.
